(19) United States
(12) Patent Application Publication
(10) Pub. No.: US 2011/0317353 A1
(43) Pub. Date: Dec. 29, 2011

(54) KEYBOARD MODULE

(75) Inventors: SUNG-MING SONG, Taipei (TW); Ping-Huang Kuo, Taipei (TW)

(73) Assignee: INVENTEC CORPORATION, Taipei (TW)

(21) Appl. No.: 12/967,616

(22) Filed: Dec. 14, 2010

(30) Foreign Application Priority Data
Jun. 25, 2010 (TW) 099120751

(51) Int. Cl. G06F 1/16

(52) U.S. Cl. 361/679.09

(57) ABSTRACT

A keyboard module is disclosed, which comprises: a keyboard; a first connecting cable; a second connecting cable; and a switch unit; wherein, the first connecting cable is arranged extending out from the keyboard and is connected to a connector of the switch unit, while the second connecting cable is also connected to the connector for electrically connecting the first connecting cable to the second connecting cable; and the second connecting cable is formed with a predefined length and shape that is specifically designed for connecting the same to a main circuit board. Thereby, the keyboard can be connected to different main circuit boards with different circuit layouts simply by changing the shape and length of its second connecting cable for mating with the design of the main circuit board that is to be connected without any other alteration in its specification, so that the universality of the keyboard is enhanced.

### FIELD OF THE INVENTION

The present invention relates to a keyboard for notebook computers, and more particularly, to a keyboard module with high universality that is capable of connecting to different main circuit boards by the use of different connecting cables of different shapes and lengths.

### BACKGROUND OF THE INVENTION

Please refer to FIG. 1, which is a schematic diagram showing how a conventional keyboard is fitted on a notebook computer. As shown in FIG. 1, it is general for a common notebook computer 8 to have an accommodation region 82 being formed on the top surface of its housing 81 that is used for receiving its keyboard 9. Moreover, with respect to a membrane 91 that is arranged extending out from the bottom of the keyboard 9, an opening 83 is formed on the accommodation region 82 at a position corresponding to the membrane 91 that is provided for the membrane 91 to thread through so as to achieve an electrical connection with a main circuit board disposed inside the notebook computer 8.

However, since the design of modern notebook computer is changing constantly for coping with the ever-advancing technology and the demands for more powerful notebook computers, there are always a variety types of notebook computer available on the market for consumers. Ever for the same type of notebook computers, they can be graded into different classes based on their differences in function and in configuration. Therefore, it is most often to have a main circuit board that is constructed specifically for a type of notebook computer to be designed with various circuit layouts for coping with the configuration/function differences of the same type of notebook computers. Nevertheless, if the position of the keyboard connector is changed with the change of the circuit layout of the main circuit board for the notebook computer 8, it is more than likely that the electric connection between the original keyboard 9 and the main circuit board with new circuit layout may not be able to achieve through the membrane 91, and consequently, a new keyboard that is specifically designed for the main circuit board with the new circuit layout is required. As a result, the more types of notebook computer that are being designed and produced, the more keyboards of different configurations that are specifically designed for those different types of notebook computers will be required. Hence, the types of parts required to be manufactured by the notebook computer manufacturers are increasing and thus the inventory parts are increased, so that the manufacturing cost is increased as well.

In view of the aforesaid problem, there are already many related studies. One of which is a connector for assembling keyboard module with notebook computer, disclosed in TW Pat. No. 373823. The aforesaid connector is formed as an internal connector fixed on the main circuit board of a notebook computer that is provided for a keyboard to connect therewith. In addition, the keyboard is configured with an output cable that is connected to an adaptor connector fixedly mounted at the back of the keyboard, whereas the adaptor is further configured with an inset seat that is provided for connecting to the connector fixed on the main circuit board. Although with the aforesaid connector, the means for connecting keyboards and main circuit board in notebook computers can be standardized, nevertheless, it still have problem for connecting an existing keyboard to a new main circuit board when the position of the main circuit board is changed.

Moreover, there is a keyboard connecting interface being composed of a keyboard, a circuit board and a package that is disclosed in TW Pat. No. 543863. Wherein, the keyboard is connected to the circuit board by the use of a membrane extending therefrom while the circuit board is disposed inside the package, by that the membrane is pressed by a pressure block of the package for enabling the same to engage exactly with a signal input of the circuit board. Thereby, with the aforesaid modularized design, various keyboards whose the positions of their membranes are different from each other as they are manufactured by different manufacturers with different designed can be adapted to be connected to a same main circuit. However, the aforesaid patent did not describe how the signal input of the circuit board is to connect with the main circuit board. Thus, the problems caused by the differences existed between different keyboards of different manufacturers can be overcome by the aforesaid TW patent, it still have problem for connecting an existing keyboard to a new main circuit board when the position of the main circuit board is changed. In addition, as the circuit board of the keyboard connecting interface is packed inside the package, not only the overall thickness of the connecting interface is increased, but also the complexity of the connecting interface is increased, which are all going to adversely affect the keyboard assembly with respect to its universality.

Therefore, it is in need of a keyboard module with good universality.

### SUMMARY OF THE INVENTION

The primary object of the present invention is to provide an improved keyboard module, which has a connector formed at its switch unit that is provided for a first connecting cable and a second connecting cable of a keyboard to connect thereto while enabling the two cables to connect electrically with each other, and thereby, not only the universality of the keyboard is enhanced, but also the manufacturing cost can be reduced.

To achieve the above object, the present invention provides a keyboard module, which comprises: a keyboard; a first connecting cable, extending from the keyboard; a second connecting cable; and a switch unit formed with a connector; wherein, the first connecting cable is connected to the connector of the switch unit, while the second connecting cable is also connected to the connector, and thereby the second connecting cable is electrically connected to the first connecting cable.

It is noted that the arrangement of the switch unit in the present invention is for enabling the first connecting cable and the second connecting cable to electrically connect with each other while the second connecting cable is specifically designed for connecting to a main circuit board. Thereby, the keyboard can be connected to different main circuit boards with different circuit layouts simply by changing the shape and length of its second connecting cable for mating with the design of the main circuit board that is to be connected to the same keyboard without any other alteration in its specification, so that not only the universality of the keyboard is enhanced, but also the inventory and manufacturing cost are reduced.

Preferably, the switch unit is configured with an insulating frame while the connector is arranged at the insulating frame; and the insulating frame has a plurality of metal connecting parts disposed therein to be used for achieving the electrical connection between the first and the second connecting cables.

Preferably, each metal connecting part is configured with a first elastic member and a second elastic member at positions respectively corresponding to the first connecting cable and the second connecting cable, by that the electrically connection between the first connecting cable and the second connecting cable is ensured by the pressing of the first elastic member and a second elastic member to the first connecting cable and the second connecting cable in respective.

Preferably, the connector is arranged at a side of the switch unit.

Preferably, the switch unit is fixed to the keyboard.

Preferably, there are two lobes arranged at two ends of the switch unit, and each lobe is formed with a fixing hole that is provided for a bolt to piece therethrough for fixing the switch unit to the keyboard.

Preferably, the switch unit is fixed to the keyboard by adhering.

Preferably, the switch unit is fixed to the keyboard by the use of a self-adhesive backing.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing how a conventional keyboard is fitted on a notebook computer.

FIG. 2 is a three-dimensional backside view of a keyboard of the present invention.

FIG. 3A is a cross sectional view of a switch unit used in the present invention when the switch unit is not connected to the first and the second cables.

FIG. 3B is a cross sectional view of a switch unit used in the present invention when the switch unit is connected to the first and the second cables.

FIG. 4 is a schematic diagram showing how the keyboard module of the present invention can be connected.

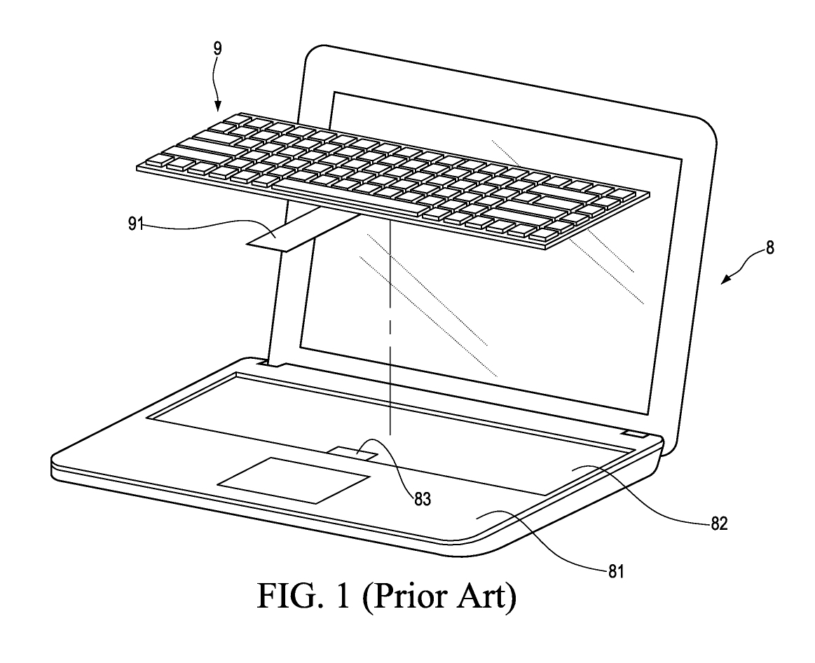

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

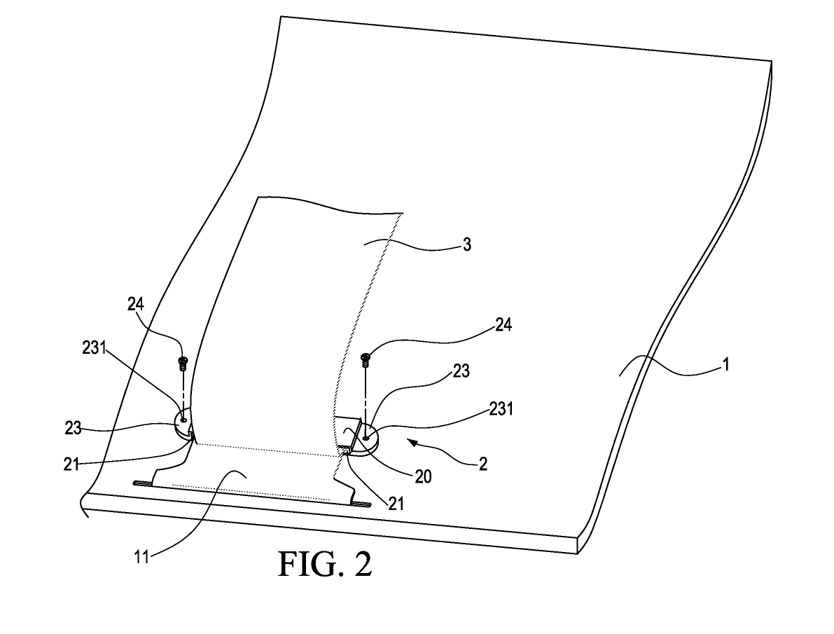

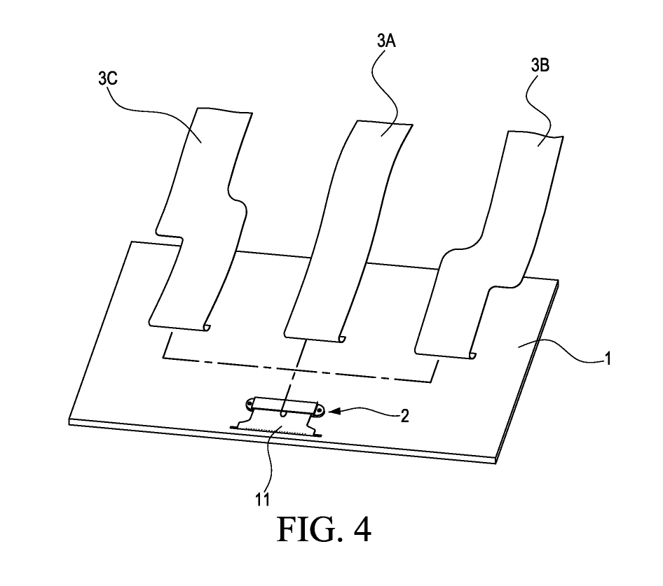

Please refer to FIG. 2 to FIG. 4, which are a three-dimensional backside view of a keyboard of the present invention, a cross sectional view of a switch unit used in the present invention when the switch unit is not connected to the first and the second cables, a cross sectional view of a switch unit used in the present invention when the switch unit is connected to the first and the second cables, and a schematic diagram showing how the keyboard module of the present invention can be connected.

The keyboard module is primarily comprised of a keyboard 1, a first connecting cable 11, a switch unit 2 and a second connecting cable 3.

The first connecting cable 11 is arranged for enabling the same to extend from the bottom of the keyboard 1.

The switch unit 2 is further configured with an insulating frame 20 that is provided for a connector 21 to be formed thereat; and the connector 21 is designed for allowing the first connecting cable 11 and the second connecting cable to connect thereto simultaneously. In addition, as the insulating frame 20 further has a plurality of metal connecting parts 4 disposed therein, they can be used for achieving the electrical connection between the first and the second connecting cables 11, 3.

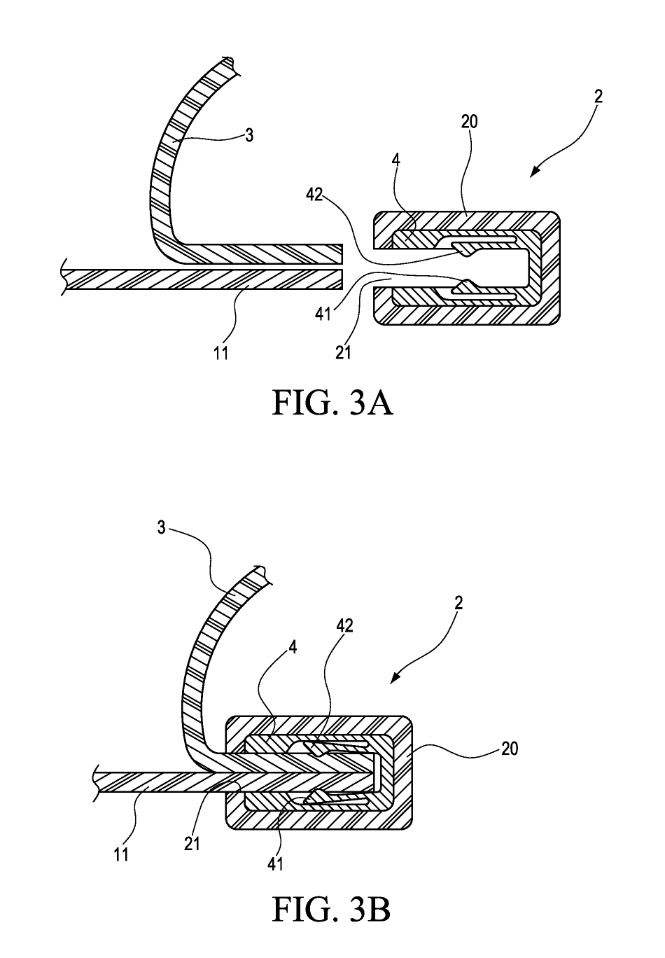

In this embodiment, the connector 21 is arranged at a side of the switch unit 2. As shown in FIG. 3, each of the metal connecting part 4 is formed as a U-shaped member that is configured with a first elastic member 41 and a second elastic member 42 at positions respectively corresponding to the first connecting cable 11 and the second connecting cable 3, by that when the first connecting cable 11 and the second connecting cable 3 are connected to the connector 21 at the same time, the electrically connection between the first connecting cable 11 and the second connecting cable 3 is ensured by the pressing of the first elastic member 41 and a second elastic member 42 to the first connecting cable 11 and the second connecting cable 3 in respective.

Moreover, there are two lobes 23 arranged extending from two ends of the insulating frame 20 of the switch unit 2, whereas each lobe 23 is formed with a fixing hole 231 that is provided for a bolt 24 to piece therethrough for fixing the switch unit 2 to the bottom of the keyboard 1.

In addition, the second connecting cable 3 is formed with a predefined length and shape that is specifically designed for connecting the switch unit 2 to a main circuit board of a corresponding notebook computer as the second connecting cable 3 is connected to the connector 21 by an end thereof.

As the switch unit 2 of the invention is configured with a connector 21 that is designed for allowing a first connecting cable 11 and a second connecting cable 3 to connect thereat simultaneously while the first connecting cable 11 is extending from a keyboard 1 and the second connecting cable 3 is connected to a main circuit board, an electrical connection between the first connecting cable 11 and the second connecting cable 3 can be ensured through the plural metal connecting parts 4, it is possible to connect the keyboard 1 to different main circuit boards with different circuit layouts simply by the use of different second connecting cables 3A, 3B and 3C of different lengths and shapes for mating with the design of the main circuit board without any other alteration in the keyboard's specification, so that not only the universality of the keyboard 1 is enhanced, but also the inventory as well as the manufacturing cost can be reduced.

In addition to the use of a blot for fixing the switch unit to the keyboard, as shown in the aforesaid embodiment, the switch unit can be fixed to the keyboard by adhering. For instance, the switch unit can be fixed to the keyboard by the use of a self-adhesive backing, such as a double-sided adhesive tape, etc.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A keyboard module, comprising:
a keyboard;
a first connecting cable, extending from the keyboard;
a second cable; and
a switch unit, having a connector provided for the first connecting cable and the second connecting cable to connected thereto while enabling the first connecting cable and the second connecting cable to electrically connect to each other.

2. The keyboard module of claim 1, wherein the switch unit is further configured with an insulating frame that is provided for the connector to be arranged at the insulating frame; and the insulating frame further has a plurality of metal connecting parts disposed therein so to be used for achieving the electrical connection between the first and the second connecting cables.

3. The keyboard module of claim 2, wherein each of the plural metal connecting parts is configured with a first elastic member and a second elastic member at positions respectively corresponding to the first connecting cable and the second connecting cable, by that the electrically connection between the first connecting cable and the second connecting cable is ensured by the pressing of the first elastic member and a second elastic member to the first connecting cable and the second connecting cable in respective.

4. The keyboard module of claim 1, wherein the connector is arranged at a side of the switch unit.

5. The keyboard module of claim 1, wherein the switch unit is fixed to the keyboard.

6. The keyboard module of claim 1, wherein there are two lobes arranged at two ends of the switch unit, and each lobe is formed with a fixing hole that is provided for a bolt to piece therethrough for fixing the switch unit to the keyboard.

7. The keyboard module of claim 1, wherein the switch unit is fixed to the keyboard by adhering.

8. The keyboard module of claim 1, wherein the switch unit is fixed to the keyboard by the use of a self-adhesive backing.
